(19) United States
(12) Patent Application Publication
(10) Pub. No.: US 2025/0110696 A1
(43) Pub. Date: Apr. 3, 2025

(54) MULTIPLICATION METHOD AND ELECTRONIC CIRCUIT

(71) Applicant: STMicroelectronics International N.V., Geneva (CH)

(72) Inventor: Fabrice ROMAIN, Rians (FR)

(73) Assignee: STMicroelectronics International N.V., Geneva (CH)

(21) Appl. No.: 18/903,498

(22) Filed: Oct. 1, 2024

(30) Foreign Application Priority Data
Oct. 2, 2023 (FR) 2310518

(51) Int. Cl. G06F 7/533

(52) U.S. Cl. CPC G06F 7/5332

(57) ABSTRACT

A digital multiplicand is received. An initial digital multiplier including logical 0s and 1s is also received. The initial multiplier is processed including at the beginning of each string with at least one logical 1 of the initial multiplier, by applying, or not, in a selective manner, a Booth encoding on said string so as to output a final multiplier. The multiplicand is then multiplied by the final multiplier to produce an output.

### PRIORITY CLAIM

This application claims the priority benefit of French Application for Patent No. 2310518, filed on Oct. 2, 2023, the content of which is hereby incorporated by reference in its entirety to the maximum extent allowable by law.

### TECHNICAL FIELD

Implementations and embodiments relate to the multiplication of operands in a multiplication electronic circuit, in particular to perform cryptographic computations, and more particularly to make side channel attacks (SCA) more difficult.

### BACKGROUND

The cryptographic computations should keep the confidentiality of the secret handled during the multiplication operations.

At each clock cycle, the multiplier is multiplied with the multiplicand. This generates consumption peaks and electromagnetic peaks the shape and the amplitude of which could reveal the values of the multiplier, of the multiplicand and of the contents of the accumulation registers. This might result in an extraction of the value of the secret using side channel attack (SCA) type attacks. Protecting these secrets against SCA-type attacks is difficult to achieve.

It is possible to perform an arithmetic masking of the data using a random number R. For example, the multiplication A*B is masked by performing the following operations A*(B+R)−A*R, which give the same result as that of the multiplication A*B.

Arithmetic masking is currently used in many implementation, and is most often managed at the software level. However, masking the data increases the number of operations or the hardware circuits if these are integrated in hardware. Furthermore, new machine learning techniques could make the attack successful using a unique trace and defeat the data masking countermeasures.

A multiplication device has been proposed in the United States Patent Application Publication No. 2013/0262544 (incorporated herein by reference) including an encoder implementing a Booth-2 type Booth encoding modified so as to deliver at the output of the encoder either a null code word (“zero-generation Booth code”) or a code word all bits of which are equal to 1 (“zero-avoidance Booth code”), and that being so only when the bits of the multiplier word are null.

Consequently, the Booth encoding is applied on all of the words of the multiplier with blurring with a Booth code word modified only when the multiplier word is null. Hence, this results in a potential weakness with regards to SCA attacks because only the value 0 is protected.

There is a need to provide another solution to make a multiplication circuit more robust against SCA-type attacks.

### SUMMARY

According to one aspect, a multiplication method is provided comprising: receiving a digital multiplicand; receiving a so-called “initial” digital multiplier including logical 0s and 1s; processing the multiplier including at the beginning of each string with at least one logical 1 of the initial multiplier, by applying, or not, (in other words selectively applying) a Booth encoding on said string, so as to output a so-called “final” multiplier; and multiplying the multiplicand by the final multiplier.

Thus, at each beginning of a string of 1s (a string of 1s may contain one single 1 or several consecutive 1s), it is decided whether to use the Booth encoding or not.

In other words, unlike the teachings of US 2013/0262544 which constantly applies the Booth encoding with a modification of the encoding in the particular case of a null word, the method according to this aspect provides for not systematically applying a Booth encoding but for deciding, each time a string of 1s is detected, to apply it, or not, on this detected string of 1s and of course on the 0 located just after this string of 1s.

Hence, the multiplication is done without any additional operation using only a simple operand encoding, which is more effective than masking the data from SCA attacks.

Furthermore, this solution requires no additional computation time, and a very little additional computing power (a few %).

Furthermore, thanks to this decision to proceed, or not, with a Booth encoding, an 8-bit operand for example could be encoded on average with 16 different values, which makes the identification of an operand much more difficult during an SCA attack.

Although the decision to perform, or not, the Booth encoding on a string of 1s could be made according to any criterion, it is particularly advantageous to make this decision randomly, which makes identification of the operands even more difficult.

Thus, according to one implementation, the method further comprises receiving a pseudo-random piece of digital data. Applying a Booth encoding on said string, or not, depends on the logical value of the bit of said pseudo-random piece of data coincident with the beginning of said string.

For example, the Booth encoding may consist of Booth-1 encoding or Booth-2 encoding.

According to another aspect, a multiplication electronic circuit is provided, for example an integrated circuit, comprising: a first input for receiving a digital multiplicand; a second input for receiving an initial digital multiplier including logical 0s and 1s; a first stage configured to receive the initial digital multiplier, and to apply, or not, (in other words selectively apply) at the beginning of each string with at least one logical 1 of the multiplier, a Booth encoding on said string and output a final multiplier; and a multiplication stage configured to perform the multiplication of the multiplicand by the final multiplier.

According to one embodiment, the circuit further comprises a third input for receiving a pseudo-random piece of digital data and the first stage is configured to apply, or not, the Booth encoding on said string depending on the logical value of the bit of said pseudo-random piece of data coincident with the beginning of said string.

The Booth encoding may consist of Booth-1 encoding or Booth-2 encoding.

According to one embodiment, the circuit is clocked by a clock signal, the multiplicand comprises a series of n-bit words, the multiplier comprises a series of k-bit words, for example k=8, the pseudo-random piece of digital data comprises a series of j-bit words (j=k for a Booth-1 encoding and j=k/2 for a Booth-2 encoding, for example), at each cycle of the clock signal, the first stage is configured to receive a word of the initial multiplier, a word of the pseudo-random piece of data, and to output a j-symbol word (one symbol contains, by the effect of the Booth encoding, several bits) of the final multiplier, and the multiplication stage comprises j multiplexers respectively controlled based on the j symbols of the word of the final multiplier.

These multiplexers are configured to: receive, during said cycle, on their multiplexer inputs, input words selected from among the group formed by a null word, a multiplicand word, the opposite of this word, words shifted to the left of the word of the multiplicand and said opposite word, the double of the word of the multiplicand, the opposite of this double, words shifted to the left of the double of the word of the multiplicand and the opposite of this double, and output on their respective output, during the cycle of the clock signal, the partial products resulting from the respectively selected multiplexer inputs.

The outputs of the multiplexers are connected to the inputs of a backup adder stage.

The double of the word of the multiplicand, the opposite of this double and the words shifted to the left of the double of the word of the multiplicand and the opposite of this double are used in the Booth-2 encoding which is particularly advantageous because the number of multiplexers is reduced.

### BRIEF DESCRIPTION OF THE DRAWINGS

Other advantages and features of the invention will become apparent upon examining the detailed description of non-limiting embodiments and implementations, and from the appended drawings wherein:

FIG. 1 illustrates a multiplication electronic circuit;

FIG. 2 illustrates an implementation of the multiplication method;

FIGS. 3 to 6 illustrate embodiments for implementing, in a pseudo-random manner, a Booth-1 type Booth encoding; and

FIGS. 7 to 9 illustrate embodiments for implementing a Booth-2 type encoding.

### DETAILED DESCRIPTION

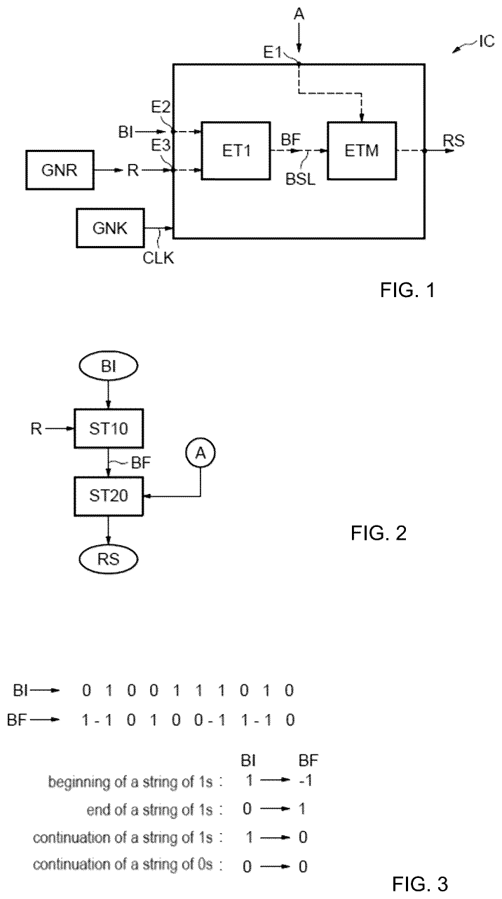

FIG. 1 illustrates a multiplication electronic circuit IC, for example an integrated circuit, comprising: a first input E1 for receiving a digital multiplicand A; and a second input for receiving an initial digital multiplicand BI including logical 0s and 1s.

The circuit also includes a first stage circuit ET1 configured to receive the initial digital multiplier BI and, to apply, or not, (in other words selectively apply) at the beginning of each string with at least one logical 1 of the multiplier, a Booth encoding on said string and output a final multiplier BF.

The circuit further includes a multiplication stage circuit ETM configured to perform the multiplication of the multiplicand A by the final multiplier BF and to output the result RS of the multiplication.

As one could see in more detail hereinafter, the multiplication stage ETM includes, in particular, a given number of multiplexers controlled by a selection word BSL obtained from the final multiplier BF.

Moreover, in practice, the circuit is clocked by a clock signal CLK output by a clock generator GNK, with a conventional structure known to a person skilled in the art, and the multiplicand A comprises a series of n-bit words.

The initial multiplier BI comprises a series of k-bit words, for example bytes (k=8).

The circuit herein includes a third input E3 configured to receive a pseudo-random piece of digital data R output by a random number generator GNR with a conventional structure known to a person skilled in the art.

The pseudo-random piece of digital data R comprises a series of j-bit words (one could see in more details hereinafter that j could be equal to k or k/2 depending on the used Booth encoding type).

And, at each cycle of the clock signal CLK, the first stage circuit ET1 is configured to receive a word of the initial multiplier BI, a word of the pseudo-random piece of data and to output a j-symbol word of the final multiplier BF from which selection words BSL will be determined.

FIG. 2 illustrates an implementation of the multiplication method.

The method comprises receiving the initial digital multiplier BI and receiving the pseudo-random piece of digital data R.

Afterwards, a step ST10 comprises processing the initial multiplier including at the beginning of each string with at least one logical 1 of the initial multiplier, by applying, or not, (in other words selectively applying) a Booth encoding on said string so as to output the final multiplier BF.

The method also comprises receiving the digital multiplicand A, and in a step ST20, multiplying the multiplicand A by the final multiplier BF so as to output the result RS.

Reference is now made more particularly to FIGS. 3 to 6 to illustrate embodiments and implementations of the invention implementing, in a pseudo-random manner, a Booth-1 type Booth encoding.

The Booth-1 encoding is well known to a person skilled in the art.

The principles thereof are recalled in FIG. 3.

The word BI illustrated as example at the top of FIG. 3 is encoded by the Booth-1 encoding to become the word BF illustrated under the word BI.

More particularly, a string of 1 includes 1 or several consecutive 1s. Such a string ends in a 0 and is possibly, yet not necessarily, bound by two 0s.

When a bit of the word BI is a 1 which marks the beginning of a string of 1s, this 1 is encoded in −1.

When a 0 value bit of the word BI marks the end of a string of 1s, it is encoded in 1.

When a 1 is located in a string of 1s, it is encoded in 0.

Finally, when a 0 is located in a string of 0s, it is encoded in 0.

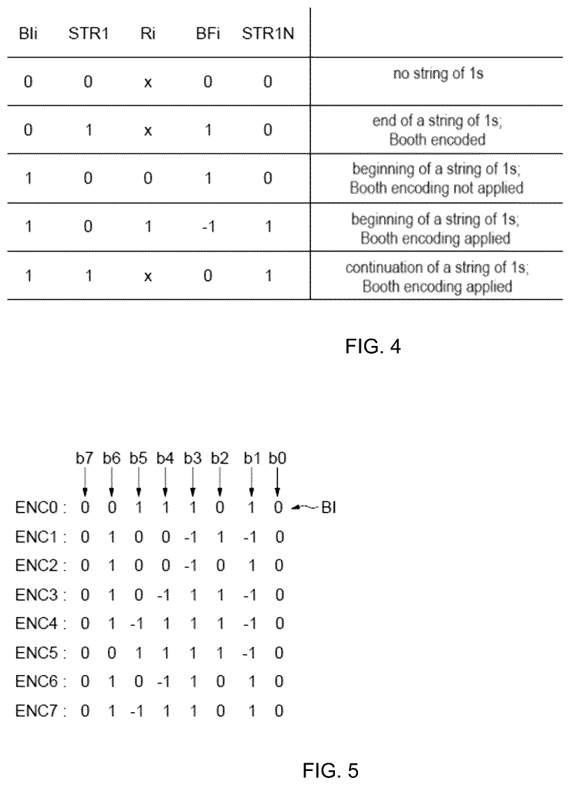

Reference is now made to FIG. 4 which illustrates more particularly the case where a Booth-1 encoding is applied, or not, at the beginning of a string of 1s.

In this respect, a bit STR1 is used which, depending on its value, indicates before processing a current bit BIi of the initial multiplier word, whether this is actually a string of 1s encoded with a Booth-1 encoding, or not.

The reference STR1N refers to the new value of the bit STR1 after processing of the bit BIi.

Thus, if the bit BIi amounts to 0 and the bit STR1 amounts to 0 (for example) then this means that is not a string of 1s.

In this case, irrespective of the value of the bit Ri of the pseudo-random piece of data, the bit BFi is equal to 0 and the new value STR1N of the bit STR1 is unchanged and remains equal to 0.

Conversely, if the bit BIi is equal to 0 and the bit STR1 has the value 1, then this means, irrespective of the value of the bit Ri, that this bit BIi marks the end of a string of 1s encoded with the Booth-1 encoding.

Consequently, the bit BFi takes on the value 1 and the new value STR1N of the bit STR1 amounts to 0.

If the bit BIi amounts to 1 and the bit STR1 amounts to 0, then this means that this is the beginning of a string of 1s.

In this case, the value of the bit of the pseudo-random piece of data Ri will determine whether the Booth encoding should be applied or not on the string of 1s.

For example, if Ri is equal to 0, then the Booth encoding is not applied on the string of 1s.

Consequently, the bit BFi keeps the same value as the value of the bit BIi, i.e. in this case the value 1 and the new value STR1N of the bit STR1 remains unchanged and equal to 0.

Conversely, if, as illustrated in the next row of the table, the value of the pseudo-random bit Ri amounts to 1, then the Booth encoding is applied on the string of 1s.

Consequently, the bit BFi is encoded at −1 and the new value STR1N of the bit STR1 amounts to 1.

Finally, as illustrated in the last row of the table, if the bit BIi amounts to 1 and the bit Str1 amounts to 1, this means that this bit BIi is found within a string of 1s encoded with the Booth-1 encoding.

In this case, irrespective of the value of the bit Ri, the bit BFi amounts to 0 and the new value STR1N of the bit STR1 remains unchanged and is equal to 1.

The bits BIi, as well as the bit STR1N are determined by the following logical equations:

ABS(BFi)=BIi XOR STR1

SIGN(BFi)=BIi AND (NOT STR1) AND Ri

STR1N=BIi AND (STR1 OR Ri)

In these equations, ABS refers to the absolute value and SIGN refers to the sign.

A person skilled in the art should know how to make a hardware encoder out of logical elements to implement the logical equations hereinabove.

FIG. 5 illustrates different possible combinations for encoding a byte BI including the bits b0 to b7.

The reference ENC0 refers to a word BF identical to the word BI since no Booth encoding is applied on the strings of 1s of the word BI.

In the encoding ENC1, the Booth encoding is applied on all of the strings of 1s of the word.

In the encoding ENC2, the Booth encoding is not applied on the first string of 1s (the bit b1) but only on a second string of 1s which starts at the bit b3.

In the encoding ENC3, the Booth encoding is applied on the first string of 1s (the bit b1), the Booth encoding is not applied on a second string of 1s (the bit b3) but is applied on a third string of 1s which starts at the bit b4.

In the encoding ENC4, the Booth encoding is applied on the first string of 1s (the bit b1), the Booth encoding is not applied on a second string of 1s (the bit b3) nor on a third string of 1s (the bit b4) but is applied on a fourth string of 1s (the bit b4).

In the encoding ENC5, the Booth encoding is applied only on the first string of 1s (the bit b1), and the Booth encoding is not applied on the other strings of 1s.

In the encoding ENC6, the Booth encoding is not applied on the first string of 1s (the bit b1) nor on a second string of 1s (the bit b3) but is applied on a third string of 1s (the bits b4 and b5).

In the encoding ENC7, the Booth encoding is not applied on the first string of 1s (the bit b1) nor on a second string of 1s (the bits b3 and b4) but is applied on a third string of 1s (the bit b5).

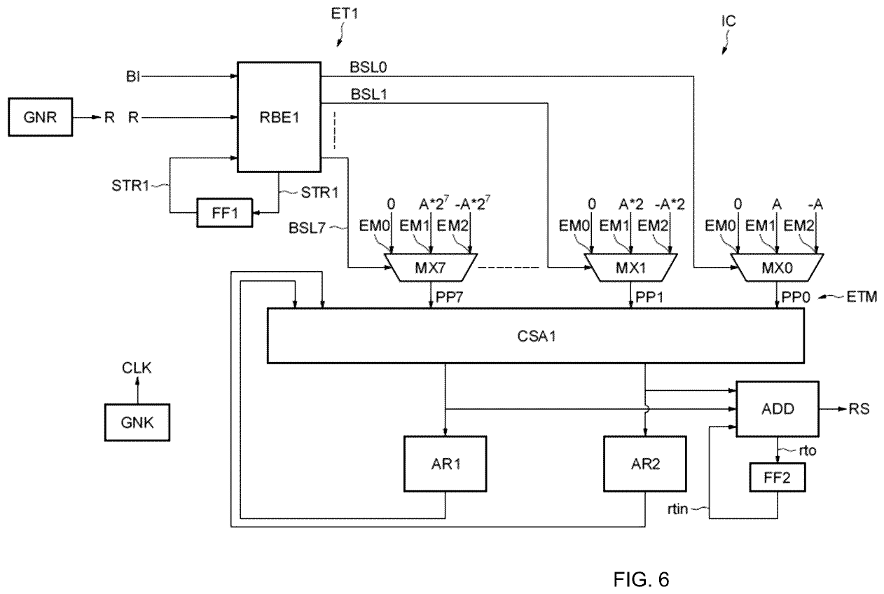

Reference is now made more particularly to FIG. 6 to describe an embodiment of a multiplication circuit allowing implementing the method that has just been described using the Booth-1 encoding.

The circuit IC includes the clock generator GNK outputting the clock signal CLK as well as the generator of numerous pseudo-random numbers GNR outputting the pseudo-random piece of digital data R.

Each pseudo-random piece of data R includes a series of j-bit words, herein bytes (j=8).

The initial multiplier BI comprises a series of k-bit words, herein bytes (k=8) and the multiplicand A comprises a series of n-bit words.

The first stage ET1 includes a Booth-1 encoder implementing the above-mentioned logical equations.

The encoder RBE1 is configured, at each cycle of the clock signal CLK, to receive a word of the initial multiplier BI, a word of the pseudo-random piece of data R and to output a 8-symbol word of the final multiplier BF from which a selection word with 8 symbols BSL0-BSL7 will be generated (one symbol includes several bits) intended, as one could see in more details hereinbelow, to control j (herein j=8) multiplexers MX0-MX7 of the multiplication stage ETM.

Each multiplexer MXi includes three inputs EM0, EM1, EM2, which could be selected by the corresponding symbol BSLi.

The input EM0 receives a null word.

The input EM1 receives a word of the multiplicand or a word shifted to the left of this multiplicand.

Thus, the multiplexer MX0 receives on its input EM1 the n-bit word of the multiplicand A.

The input EM1 of the multiplexer MX1 receives this word shifted to the left by 1 bit and the input EM1 of the multiplexer MX7 receives this n-bit word shifted to the left by 7 bits.

The input EM2 of each multiplexer receives the opposite of the word received at the input EM1.

If the selection symbol BSLi amounts to 0, the input EM0 of the corresponding multiplexer is selected.

If the selection symbol BSLi amounts to 1, the input EM1 is selected.

If the selection symbol BSLi amounts to 2, the input EM2 is selected.

And, within the Booth encoder RBE1, the symbol BSLi is generated for example in the following way starting from the value of the bit BFi:
BSLi=0 if BFi=0
BSLi=1 if BFi=1 and
BSLi=2 if BFi=−1

The multiplexers deliver on their respective output, during the cycle of the clock signal CLK, the partial products PP0-PP7 resulting from the respectively selected inputs of the multiplexers.

The outputs of the multiplexers are connected to the inputs of a backup adder stage CSA1 (Carry Save Adder).

The structure of such a backup adder stage is well known to a person skilled in the art as illustrated by the book by Parhami Behrooz, entitled “Computer arithmetic: algorithms and hardware designs” (2^{nd} edition), 2010, New York Oxford University Press (incorporated herein by reference).

Moreover, the multiplication stage ETM includes two accumulation registers AR1 and AR2 looped back between the outputs of the backup adder CSA1 and inputs of this backup adder.

An adder ADD receives the low-weight bits delivered on the outputs of the backup adder and successively outputs the result words RS.

A Flip-Flop type latch FF2, receives at its input the carry rt0 delivered at the output of the adder ADD and delivers again this carry rtin at the input in the next cycle.

Moreover, another Flip-Flop type latch, FF1, is looped back on an output of the encoder RBE1 and an input of this encode.

More specifically, this latch FF1 is intended to receive the value of the bit STR1 which has been generated at the end of the current byte to deliver it again when processing the next byte.

Indeed, for example, a string of 1s could lie astride two consecutive bytes.

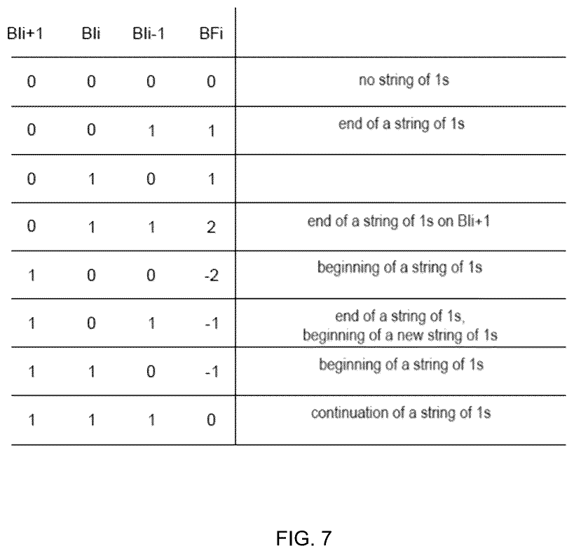

Reference is now made more particularly to FIGS. 7 to 9 to describe an embodiment and implementation of the invention using a Booth-2 type encoding.

The conventional Booth-2 encoding is well known to a person skilled in the art and its encoding table is illustrated in FIG. 7.

This consists of an encoding over 2 bits. In other words, the bit BIi as well as the next bit BIi+1 are encoded in a symbol BFi (which includes several bits). The previous bit BIi−1 allows determining whether a string of 1s is pending.

The meanings of the main lines of the Booth-2 encoding are mentioned in the right part of FIG. 7 opposite the corresponding lines.

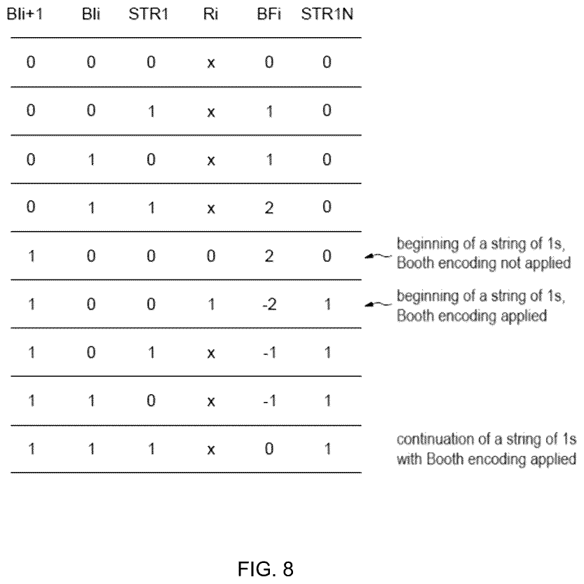

FIG. 8 illustrates the Booth-2 encoding table modified so as to involve the bit of the pseudo-random piece of data Ri.

Herein again, like in the previous embodiment using the Booth-1 encoding, depending on the logical value of the bit Ri, it is decided whether, at the beginning of a string of 1s, this string of 1s is encoded with the Booth-2 encoding or not.

Thus, like in the previous case, if the bit Ri amounts to 0 (for example), then the Booth encoding is not applied on this string of 1s whereas if the bit Ri amounts to 1, then the Booth encoding is applied on the string of 1s that will begin next.

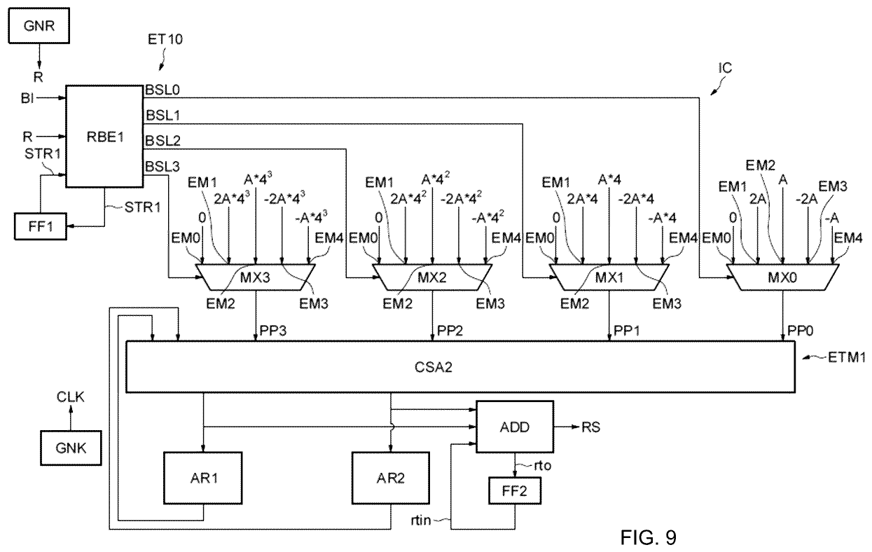

FIG. 9 illustrates an embodiment of a circuit IC implementing the Booth-2 encoding using the pseudo-random piece of data R.

The pseudo-random piece of data R herein includes 4-bit words (j=4).

Herein again, the words of the initial multiplier consist of bytes and the words of the multiplicand consist of n-bit words.

A person skilled in the art should know how to physically make the encoder RBE2 implementing the encoding of FIG. 8 using logical elements.

Like in the embodiment of FIG. 6, a latch FF1 is provided in order to store the value of the bit STR1 determined at the end of the current byte to re-inject it in the encoder RBE2 at the beginning of the next byte.

Unlike the embodiment of FIG. 6, the multiplication stage ETM1 herein includes 4 multiplexers MX0-MX3.

Each multiplexer includes 5 inputs EM0-EM4.

The input EM0 receives a null word.

The input EM2 receives the word of the multiplicand A or this word shifted to the left.

Thus, the input EM2 of the multiplexer MX0 receives the word of the multiplicand A.

The input EM2 of the multiplexer MX1 receives this word shifted by 2 bits to the left.

The input EM2 of the multiplexer MX2 receives this word shifted by 4 bits to the left.

The input EM2 of the multiplexer MX3 receives the word of the multiplicand shifted by 6 bits to the left.

The input EM1 of each multiplexer receives the double of the word of the multiplicand possibly shifted to the left in the same way as for the inputs EM1.

The input EM3 of each multiplexer receives the opposite of the word received at the input EM1.

The input EM4 of each multiplexer receives the opposite of each word received at the input EM2.

The multiplexers are controlled by a selection word with 4 symbols BSL0-BSL3.

Each symbol BSLi could take on the values 0, 1, 2, 3, 4 so as to control the inputs EM0, EM1, EM2, EM3, EM4 respectively.

If bit BFi amounts to 0, then BSLi amounts to 0.

If BFi amounts to 2, then BSLi amounts to 1.

If BFi amounts to 1, then BSLi amounts to 2.

If BFi amounts to −2, then BSLi amounts to 3.

If BFi amounts to −1, then BSLi amounts to 4.

The 4 partial products PP0-PP3 are delivered at the input of a backup adder stage CSA2 with a conventional structure.

The remainder of the multiplication stage ETM1 is similar to what has been described with reference to FIG. 6.

1. A multiplication method, comprising:
receiving a digital multiplicand;
receiving an initial digital multiplier including logical 0s and logical 1s;
processing the initial digital multiplier, at a beginning of each string with at least one logical 1 of the initial digital multiplier, by selectively applying a Booth encoding on said string with at least one logical 1 so as to output a final multiplier; and
multiplying the digital multiplicand by the final multiplier.

2. The method according to claim 1, further comprising:
receiving a pseudo-random piece of digital data; and
wherein selectively applying comprises applying the Booth encoding on said string dependent on a logical value of a bit of said pseudo-random piece of data which coincides with the beginning of said string with at least one logical 1.

3. The method according to claim 1, wherein the booth encoding is a Booth-1 encoding.

4. The method according to claim 1, wherein the Booth encoding is a Booth-2 encoding.

5. A multiplication electronic circuit, comprising:
a first input configured to receive a digital multiplicand;
a second input configured to receive an initial digital multiplier which includes logical 0s and logical 1s;
a first stage circuit configured to receive the initial digital multiplier, and to selectively apply at a beginning of each string with at least one logical 1 of the initial digital multiplier a Booth encoding on said string with at least one logical 1 and output a final multiplier; and
a multiplication stage circuit configured to perform multiplication of the digital multiplicand by the final multiplier.

6. The circuit according to claim 5, further comprising:
a third input configured to receive a pseudo-random piece of digital data; and
wherein the first stage circuit is configured to apply the Booth encoding on said string dependent on a logical value of a bit of said pseudo-random piece of data which is coincident with the beginning of said string with at least one logical 1.

7. The circuit according to claim 6, clocked by a clock signal:
wherein the digital multiplicand comprises a series of n-bit words;
wherein the initial digital multiplier comprises a series of k-bit words;
wherein the pseudo-random piece of digital data comprises a series of j-bit words; and
wherein at each cycle of the clock signal, the first stage circuit is configured to receive a word of the initial digital multiplier, a word of the pseudo-random piece of data, and output a j-symbol word of the final multiplier;
wherein the multiplication stage comprises j multiplexers respectively controlled based on the j symbols of the word of the final multiplier and configured to receive, during said cycle, on their multiplexer inputs, input words selected from among the group formed by a null word, a multiplicand word, the opposite of this word, words shifted to the left of the word of the multiplicand and said opposite word, the double of the word of the multiplicand, the opposite of this double, words shifted to the left of the double of the word of the multiplicand and the opposite of this double and to output on their respective output, during the cycle of the clock signal, the partial products resulting from the respectively selected multiplexer inputs; and
wherein the outputs of the multiplexers are connected to the inputs of a backup adder stage.

8. The circuit according to claim 5, wherein the Booth encoding is the Booth-1 encoding.

9. The circuit according to claim 5, wherein the Booth encoding is the Booth-2 encoding.
